(19) United States
(12) Patent Application Publication
(10) Pub. No.: US 2011/0163724 A1
(43) Pub. Date: Jul. 7, 2011

(54) METHOD AND DEVICE FOR MONITORING A HYBRID VEHICLE POWER STORAGE SYSTEM

(75) Inventors: Melaine Migaud, Paris (FR); Nicolas Dollinger, Sartrouville (FR); Nicolas Robart, Issy Les Moulineaux (FR); Fabien Mercier-Calvairac, Paris (FR)

(73) Assignee: Peugeot Citroen Automobiles SA, Velizy Villacoublay (FR)

(21) Appl. No.: 13/119,085

(22) PCT Filed: Sep. 22, 2009
(86) PCT No.: PCT/FR09/51784

§ 371 Date: Mar. 15, 2011

(30) Foreign Application Priority Data
Sep. 23, 2008 (FR) 0856410

(51) Int. Cl. H02J 7/00

(52) U.S. Cl. 320/136; 180/65.29; 903/903

(57) ABSTRACT

In a hybrid vehicle system comprising an electric power storage system and an electric motor, the method includes a first step of allowing the electric power storage system to be discharged: upon detecting a condition of a charge of the electric power storage system that is greater than a first threshold to optimize power consumption; and upon detecting a condition of the charge of the electric power storage system that is greater than a second threshold to increase performance.

### CROSS-REFERENCE TO RELATED APPLICATIONS

This application is a National Stage of International Application No. PCT/FR2009/051784, filed Sep. 22, 2009, which claims priority to French Application 0856410, filed Sep. 23, 2008.

### FIELD

The invention relates to a method and device for monitoring an energy storage system for hybrid vehicle comprising an electrical storage device and an electrical machine, e.g., an electric motor. The electrical storage system contributes to satisfying the demand for an energy boost needed to increase the performance of the vehicle, for instance during the acceleration phase of the vehicle, or to the optimization of the energy consumption of the vehicle, by supplying energy to the electrical machine which operates then in motor mode, reinforcing or replacing the torque of the combustion engine.

### BACKGROUND

Monitoring systems for energy storage systems of hybrid vehicles already exist. For instance, document U.S. Pat. No. 6,321,143 discloses a system for controlling electrical energy as a function of the use of the vehicle by defining several possible states of the vehicle and by adapting the energy use or the charge in these states.

Document EP1410481 discloses a parallel system for managing the electrical energy of a hybrid vehicle which controls the power supply battery as a function of the demand and the parameters of the battery (e.g., temperature, charge state, etc).

Document U.S. Pat. No, 6,223,106 discloses a control device for hybrid vehicle which manages the electrical energy.

The prior art control methods and devices are not fully satisfactory.

### SUMMARY

To improve prior art control methods and devices, one objective of the invention is a method for controlling an energy storage system for a hybrid vehicle that includes an electrical storage device and an electrical machine. The method comprises a first stage arranged, i.e., operable, so that discharge of the storage device is authorized:
upon detection of a state of charge of the storage device greater than a first threshold for optimization of the energy consumption of the vehicle; and
upon detection of a state of charge of the storage device greater than a second threshold for increasing the performance of the vehicle;

In particular, the second threshold is established at a minimum energy value reserved for compensation of transitions.

Advantageously, the first threshold delimits an energy range of variable height above the second threshold.

One goal of the invention is also a device controlling an energy storage system for hybrid vehicle that includes an electrical storage device and an electrical machine. The device comprises:
a first threshold arranged for authorizing the optimization of the energy consumption of the vehicle when the state of charge of the storage device is greater than the first threshold; and
a second threshold arranged, i.e., operable, for authorizing increased vehicle performance when the state of charge of the storage device is greater than the second threshold.

In particular, the second threshold is fixed at a minimum energy value reserved for compensation of transitions.

Advantageously, the first threshold delimits an energy range of variable height above the second threshold.

### DRAWINGS

The invention will be better understood by reading the following description and by examining the accompanying figures. The figures are provided only for illustration purposes and are not limiting the invention.

FIG. 1 is a schematic representation of a plurality of essential elements of a hybrid vehicle for implementation of the invention;

FIG. 2 is a flowchart showing the steps of a method for monitoring an energy storage system of the hybrid vehicle according to the invention.

Identical elements retain the same indication from one figure to another.

### DETAILED DESCRIPTION

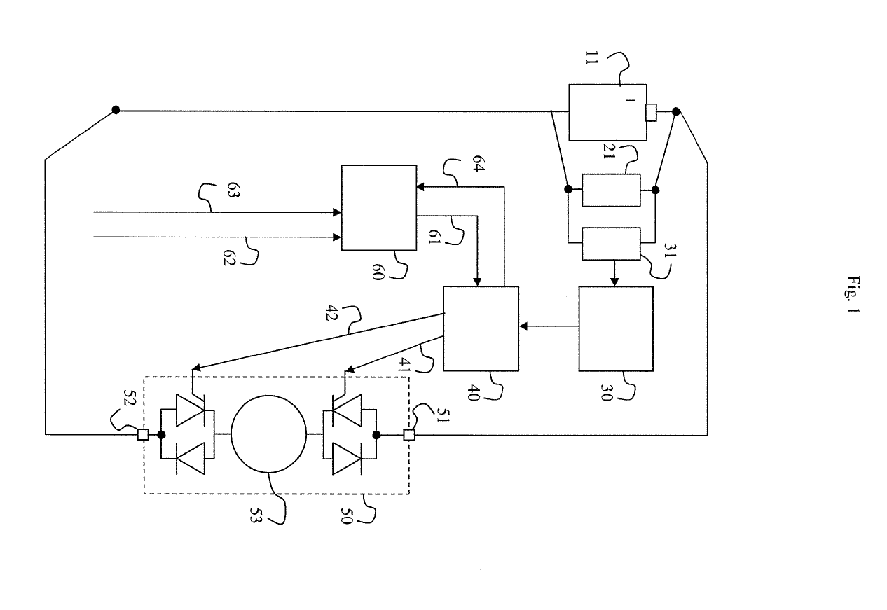

With reference to FIG. 1, a hybrid vehicle comprises an electric storage device 11 consisting of a battery, with super capacity or any other element suitable for storing in reversible manner electrical energy. Various electricity consuming devices 21 such as the head lights, the heating and air conditioning elements of the vehicle, the devices controlling the transmission, are connected to the terminals of the electrical storage device 11 and consume electrical energy which they need at the opportune time. A reversible converter 50 of electrical energy into mechanical energy consumes electrical energy supplied by the electrical storage device 11 in various situations. When a combustion engine supplies traction force to the vehicle, the electrical storage device 11 can supply an energy complement to improve performance, for instance in case of a request for more energy to accelerate the vehicle, which can be called “boost” according to the foreign language term with identical significance. The reversible converter 50 supplies energy to the electrical storage device 11 in particular when the vehicle decelerates or drives downhill, but this is not necessarily sufficient to ensure a zero energy balance. The reversible converter 50 must also supply electrical energy to recharge the electrical storage device 11 at other times when the combustion engine is running.

One terminal 51 of the reversible converter 50 is connected with the positive pole of the electrical storage device 11 and the other terminal 52 is connected with the negative pole of the electrical storage device 11. Between terminals 51 and 52, the reversible converter 50 comprises for instance an electrical machine 53, e.g., an electric motor, which supplies mechanical energy in motor mode when the reversible converter 50 is commanded by a signal element 41 and absorbs mechanical energy in generator mode to recharge the electrical storage device 11 when the reversible converter 50 is commanded by a signal 42. Signals 41 and 42 are controlled by a module 40, which is usually an electronic unit. Module 40 establishes the values of the signals 41 and 42 as a function of torque data supplied to the electrical machine 53 or absorbed by the electrical machine 53. To this end, module 40 receives various commands, for instance from the braking units or acceleration units of the vehicle or from a module 30, which is usually an electronic unit, which is arranged, i.e., operable, for receiving a charge level of the storage device 11 from a sensor 31, which in a known manner measures the voltage at the terminals of the electrical storage device 11 and estimates its impedance starting from the electrical current passing through the electrical storage device 11. More in particular, module 40 receives a control command signal 61 from a module 60, which is usually an electronic module. Module 60 is arranged, i.e., operable, for authorizing in a controlled manner a discharge of the storage device 11. As we shall see in the following description, signal 61 contains an instruction regarding the energy or power to be consumed by the reversible converter 50 starting from storage device 11, following a request for complementary energy received through a signal 63, in order to increase the performance of the vehicle or following a request for useable energy, received through a signal 62, for optimizing the energy consumption of the vehicle.

A performance increase, for instance when accelerating, consists in general of adding the torque of the electrical machine 53 to the torque of the combustion engine in order to increase the acceleration of the vehicle. Optimization of the energy consumption of the vehicle, for instance at low traveling speed, consists in general of using mainly the torque of the electrical machine 53 and turning off the combustion engine so that fuel consumption of the vehicle is reduced.

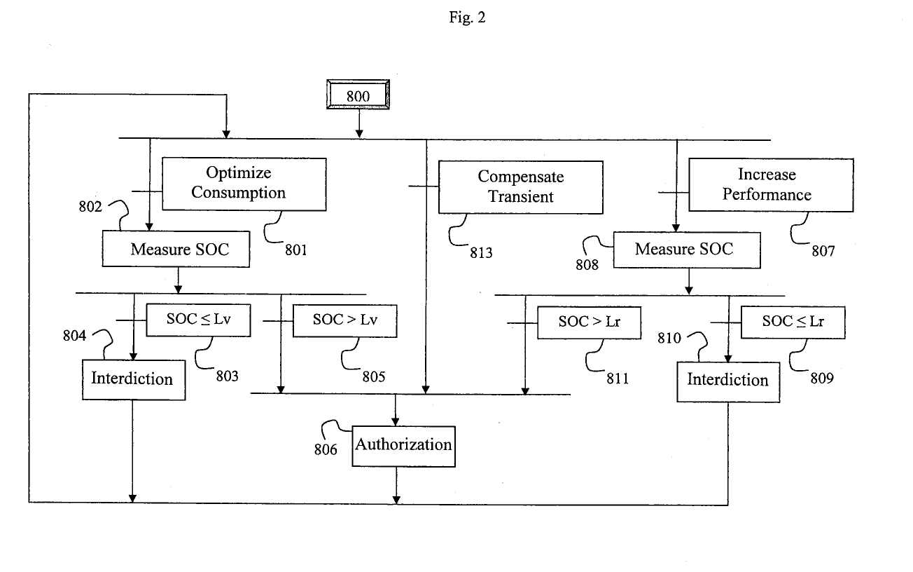

Module 60 is arranged, i.e., operable, for instance by means of a microprocessor and a digital or analog memory, for executing the method explained here with reference to FIG. 2.

With reference to FIG. 2, the control method comprises a first stage 806 arranged so that discharge of the storage device 21 is authorized when one of the three following transitions is validated.

A transition 805 is validated upon detection of a state of charge (SOC) of the storage device 11 greater than a first threshold Lv, which is the low limit of the green energy range, especially dimensioned to optimize the energy consumption of the vehicle, for instance at low cruising speed or during city driving.

A transition 811 is validated upon detection of a state of charge of the storage device greater than a second threshold Lr, which is the lower limit of the orange energy range, especially dimensioned to increase the performance of the vehicle, for instance when accelerating.

A transition 813 is validated by a request for energy to compensate transitions. The validation of this transition is not necessarily linked to logic detection but can result naturally from a transitional phenomenon. The second threshold Lr is also the high limit of the minimum red energy range especially dimensioned so that the energy quantity is rapidly repaid in case of reduction, through direct recharging of the storage device 11 via the combustion engine or through recuperation during a weak deceleration.

The value of Lr determines the guaranteed minimum dynamic performance of the vehicle.

The sustainability of the vehicle's energy rests on energy which is not accessible by the consumption optimization strategy, the priority recharge relative to the green range, the decanting of the consumption optimization energy when it is available and a quantity of energy which by design is easily repaid. To this end, the second threshold is fixed at a minimum energy value reserved for compensation of transitions.

The first threshold, which is the low limit of the green range, is also the high limit of the orange range. By making the threshold parametric or a function of the lifetime conditions of the vehicle, the first threshold will delimit an energy range with variable height above the second threshold.

The transition 805 is validated following a stage 802 which measures the level or the state of charge of the storage device 11 SOC (State Of Charge) when a request for consumption optimization validates a transition 801.

A transition 803 is validated following stage 802 when the level or the state of charge SOC of the storage device 11 is smaller than or equal to threshold Lv, so that a stage 804 is activated which interdicts then the discharge of the storage device 11 to optimize the energy consumption of the vehicle.

The transition 811 is validated following a stage 808 which measures the level or state of charge of the storage device 11 SOC when a request for increased performance validates a transition 807.

A transition 809 is validated following stage 808 when the level or the state of charge of the storage device 11 SOC is smaller than or equal to a threshold Lr, so that a stage 810 is activated which interdicts then the discharge of the storage device 11 to increase the performance of the vehicle.

To implement the method, a device for controlling an energy storage system for the hybrid vehicle that includes the electrical storage device 11, the electrical machine 53 and the module 60, comprises for instance in digital or analog memory (not shown):
the first threshold Lv, wherein the device is arranged, or operable, to authorize the optimization of the energy consumption of the vehicle when the state of charge of the storage device 11 is greater than the first threshold Lv; and
the second threshold Lr, wherein the device is arranged, or operable, for authorizing increased vehicle performance when the state of charge of the storage device 11 is greater than the second threshold Lr.

The second threshold Lr is by preference fixed at a minimum energy value reserved for compensation of transitions.

The first threshold Lv is by preference variable, delimiting an energy range of variable height above the second threshold Lr.

1.-4. (canceled)

5. A method for controlling an energy storage system for a hybrid vehicle that includes an electrical storage device and an electrical machine, said method comprising discharging the electrical storage device upon at least one of:
detection that a state of charge of the electrical storage device is greater than a first threshold for optimization of energy consumption of the vehicle; and
detection that the state of charge of the electrical storage device is greater than a second threshold for increasing performance of the vehicle, wherein the second threshold is fixed at a minimum energy value reserved for compensation of transitions.

6. The method according to claim 5, wherein the first threshold delimits an energy range of variable height above the second threshold.

7. A device for controlling an energy storage system for a hybrid vehicle that includes an electrical storage device (11) and an electrical machine (53), said device comprising:
a first threshold operable for authorizing optimization of energy consumption of the vehicle when a state of charge of the electrical storage device is greater than the first threshold; and
a second threshold operable for authorizing increased performance of the vehicle when the state of charge of the electrical storage device is greater than the second threshold, wherein the second threshold is fixed at a minimum energy value reserved for compensation of transitions.

8. The device according to claim 7, wherein the first threshold delimits an energy range of variable height above the second threshold.
